(19) United States
(12) Patent Application Publication
(10) Pub. No.: US 2005/0031340 A1
(43) Pub. Date: Feb. 10, 2005

(54) Method and a device for controlling protection or restoration paths in a hybrid optical network

(75) Inventors: Martin Vigoureux, Paris (FR); Maher Ali, Plano, TX (US); Olivier Audouin, Longsudeau (FR); Emmanuel Dotaro, Verrieres Le Buisson (FR); Richard Douville, Bretigny Sur Orge (FR); David Elie Dit Cosaque, Richardson, TX (US)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/636,530

(22) Filed: Aug. 8, 2003

(51) Int. Cl. G02F 1/00

(52) U.S. Cl. 398/5

(57) ABSTRACT

A device (D) is dedicated to controlling auxiliary paths (CP, SC) in a hybrid optical communications network comprising a multiplicity of hybrid nodes (NO) including switching means (CM1) and color converter means (CM2) and interconnected by transmission lines. The device comprises processor means (MT) adapted, in the event of a fault on at least one of the transmission lines carrying a connection and at the ends of which are two hybrid nodes (NO) adapted to effect switching in opaque mode, to command the switching means (CM1) of at least one of the hybrid nodes (NO) to switch the optical signals taking the connection to a selected auxiliary path independent of color and passing through said nodes, where applicable after color conversion of the optical signals by the associated converter means (CM2).

The field of the invention is that of wavelength division multiplex optical transport networks and more particularly that of controlling protection and restoration paths in hybrid optical networks.

In the present context, a “hybrid optical network” is a communications network including hybrid nodes interconnected by transmission lines, and a “hybrid” node is one that can switch an optical signal either in transparent mode or in opaque mode. An optical signal is switched in transparent mode if it does not pass through an opto-electronic (O/E) module or an all-optical wavelength converter module. An optical signal is switched in opaque mode if it does pass through an opto-electronic module or an all-optical wavelength converter module.

In optical networks of the above kind, to protect or restore traffic in the event of a fault on a transmission line carrying a connection used by optical signals and of a kind liable to degrade or even prevent transmission of at least one of the optical signals on that line, it is possible to use either protection paths that are predetermined (i.e. precalculated, pre-established and prereserved) or restoration paths that are partially determined or need to be determined.

These protection or restoration paths, which are referred to hereinafter as “auxiliary” paths, are either established in a so-called “end-to-end” mode between the two nodes at the ends of a connection, without passing through hybrid intermediate nodes and/or transmission lines (also known as links) used by the connection, or else they are broken down into sub-paths established between pairs of nodes of the connection, in a “sub-path” mode if the sub-path interconnects nodes that are not adjacent or as a “link” mode if the sub-path interconnects two adjacent nodes.

The protection or restoration mechanism includes switching the optical signal to (and from) the auxiliary (sub-)path. If this switching is effected in transparent mode, auxiliary paths and sub-paths passing through nodes that implement switching must therefore be determined not only as a function of an availability criterion but also as a function of a color (i.e. wavelength) criterion.

An object of the invention is to remedy this drawback.

To this end the invention proposes a method of controlling auxiliary (sub-)paths in a hybrid optical network comprising a multiplicity of hybrid nodes interconnected by transmission lines. The connections pass through the network by being switched in transparent mode at some nodes and in opaque mode at other nodes, for reasons connected with regeneration of the optical signal, which is inevitably degraded as it passes through the network.

The number of wavelength converter modules (opto-electronic modules or all-optical converter modules) being limited within the hybrid nodes, and therefore within the network as a whole, the method of the invention is characterized in that, if a fault occurs on a transmission line carrying one or more connections, it consists firstly in determining auxiliary (sub-)paths between the nodes at which a connection can be switched in opaque mode (whether this is already the case or not), and then in switching the optical signal or signals impacted by the fault that has occurred on the transmission line to an auxiliary (sub-)path defined between two hybrid nodes at the ends of the faulty line that are switched in opaque mode, where applicable after converting the color of the optical signals of the stream.

After this, if a fault occurs on a transmission line carrying a connection, only hybrid nodes capable of switching in opaque mode are used to switch optical signals to auxiliary (sub-)paths, where applicable after color conversion, and said (sub-)paths can therefore be determined independently of the color of the optical signals carried by the connection.

The optical signals are preferably switched only after receiving information reporting a fault on the transmission line carrying the connection they use.

When the auxiliary (sub-)path is for restoring traffic, it is preferably determined on receiving information reporting the fault. Similarly, if the auxiliary (sub-)path is for restoring traffic, and was partially predetermined before information reporting the fault is received, its determination is completed on receiving said information. The auxiliary (sub-)path is preferably determined or predetermined in the hybrid node that is responsible for switching on the upstream side of the fault, relative to the direction of propagation of the optical signal, but can equally well be effected in a management server coupled to said hybrid nodes.

In contrast, if the auxiliary (sub-)path is for protecting traffic, the optical signals of the received optical stream are switched automatically on receiving information reporting a fault.

The invention also provides a device for controlling auxiliary (sub-)paths in a hybrid optical network including a multiplicity of hybrid nodes, the device comprising optical signal switching means and color converter means interconnected by transmission lines.

The device is characterized in that it further comprises processor means that respond to a fault on a transmission line carrying one or more connections and at the ends of which there are two nodes adapted to effect switching in opaque mode, by commanding the switching means of at least one of said two hybrid nodes to switch the optical signals to a chosen auxiliary (sub-)path passing through them and independent of color, where applicable after color conversion by the associated converter means.

The processor means are preferably adapted to command switching of the optical signals of the stream on receiving information (or a message) reporting a fault on the transmission line carrying the connection that they use.

If the auxiliary (sub-)path is for restoring traffic, the device preferably includes calculator means for determining the (sub-)path on receiving information reporting a fault. Likewise, if the auxiliary (sub-)path is for restoring traffic and was partly predetermined before information reporting a fault is received, the calculator means are preferably responsible for completing the determination on receiving said information.

In contrast, if the auxiliary (sub-)path is for protecting traffic, the processor means automatically command switching of the received optical stream immediately they receive information reporting a fault.

The above kind of control device can be installed in a management server or in hybrid nodes of a hybrid optical network, which can additionally be equipped with an optical signal regenerator module.

Moreover, the invention applies to all types of hybrid optical network and in particular to networks for switching wavelengths, networks for switching bands of wavelengths, and fiber networks.

Other features and advantages of the invention become apparent on reading the following detailed description and examining the appended drawings, in which:

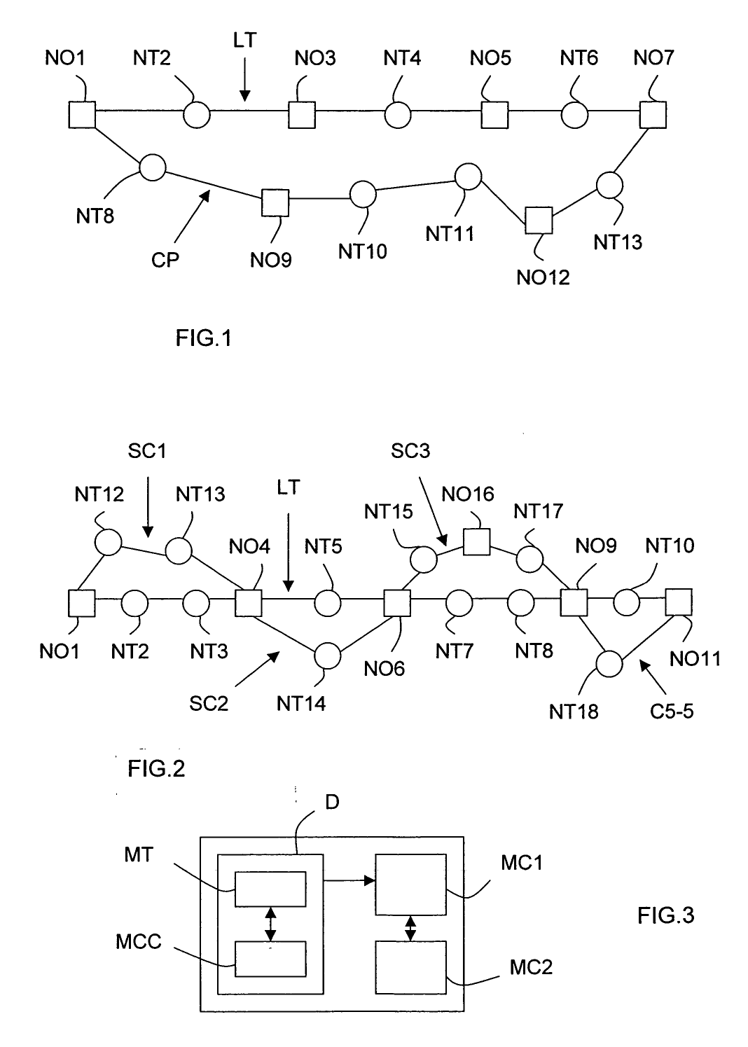

FIG. 1 is a diagrammatic illustration of an example of a transmission line of the invention, which belongs to a hybrid optical network and is associated with a protection path established in “end-to-end” mode,

FIG. 2 is a diagrammatic illustration of an example of a transmission line of the invention, which belongs to a hybrid optical network and is associated with a protection path established in “sub-path” mode, and

FIG. 3 is a diagrammatic illustration of an embodiment of a control device of the invention installed in a hybrid node.

The above figures not only constitute part of the description of the invention but also, if necessary, contribute to the definition of the invention.

A hybrid optical communications network can be represented in a highly schematic manner by a multiplicity of transmission terminals interconnected by transmission lines. In the present context, the expression “transmission terminal” means any terminal constituting a node of the network, whether it be of a “transparent” type, because it switches streams only at constant color (i.e. with the same wavelength or band of wavelengths), i.e. without color conversion, or of a “hybrid” type, because it handles at least switching of stream optical signals, with or without color conversion, or regeneration of the optical signals.

A conventional connection, also known as a working resources connection, is generally established via a series of hybrid nodes interconnected by transmission lines. The connection is generally switched in transparent mode in some nodes and in opaque mode in other nodes.

As shown in FIG. 1, the path taken by a working resources connection LT in accordance with the invention has at its two opposite ends hybrid nodes NO1 and NO7 equipped at least with a stream switching module and a color converter module, where applicable handling the regeneration of optical signals, and connected to intermediate nodes at which said connection is switched in transparent mode (in this example nodes NT2, NT4, and NT6) or opaque mode (in this example nodes NO3 and NO5). The nodes handling switching in opaque mode are equipped with a converter module, where applicable handling regeneration of the optical signals.

The regeneration of the optical signals (or stream) can be 2R (reamplification and reshaping) regeneration, for example, or 3R (reamplification, reshaping, and retiming) regeneration.

To enable traffic protection or restoration in the event of a fault on a transmission line along the path LT carrying a connection, the faulty transmission line is associated with a protection or restoration path CP. In the present context, a protection path is a transmission path whose resources have been precalculated, pre-established and prereserved, as opposed to a restoration path, whose resources have been partly determined or have to be determined to protect or restore the traffic in the event of a fault on a transmission line. Also, the expression “auxiliary path” refers either to a protection path or to a restoration path.

Three types of auxiliary path CP can be envisaged. In a first, end-to-end type, shown in FIG. 1, the auxiliary path CP connects the two end nodes NO1 and NO7 of the path LT without passing through its intermediate nodes. In the example shown, the auxiliary path CP comprises hybrid nodes NO at which the connection concerned is switched in opaque mode (end nodes NO1 and NO7 and intermediate nodes NO9 and NO12) and hybrid nodes at which said connection is switched in transparent mode (intermediate nodes NT8, NT10, NT11, and NT13).

In a second, sub-path type, shown in FIG. 2, the auxiliary path CP still connects the two end nodes NO1 and NO11 of the path LT, but is divided into auxiliary sub-paths (in this example sub-paths SC1, SC2, SC3, and SC4) passing through intermediate nodes of the path LT, at which the main and back-up connections are switched in opaque mode (in this example nodes NO4, NO6, and NO9). To be more precise, each auxiliary sub-path SC is defined between two hybrid nodes equipped with at least a stream switching module and a color converter module for regenerating optical signals, where applicable.

Thus, in the example shown: the first sub-path SC1 connects the nodes NO1 and NO4, at which the main and back-up connections are switched in opaque mode, via the nodes NT12 and NT13, at which the back-up connection is switched in transparent mode; the second sub-path SC2 connects the nodes NO4 and NO6, at which the main and back-up connections are switched in opaque mode, via the node NT14, at which the back-up connection is switched in transparent mode; the third sub-path SC3 connects the nodes NO6 and NO9, at which the main and back-up connections are switched in opaque mode, via the nodes NT15 and NT17, at which the back-up connection is switched in transparent mode, and via the node NO16, at which the back-up connection is switched in opaque mode; and the fourth sub-path SC4 connects the nodes NO9 and NO11, at which the main and back-up connections are switched in opaque mode, via the transparent node NT18, at which the back-up connection is switched in transparent mode.

In this second type of protection path, the path taken by the main connection can therefore be divided into portions (also known as sub-paths) each of which is defined between two of its hybrid nodes NO, at which the main connection is switched in opaque mode, and which are interconnected by an auxiliary sub-path SC.

The third type of protection path, also known as a link, is a variant of the second type, in which the sub-path (or link) is defined between two adjacent nodes of the connection concerned.

In the arrangement proposed by the invention, it is therefore nodes NO handling color conversion and stream switching that handle switching of the streams that they receive to the respective auxiliary path CP to which they are connected in the event of a fault on the transmission line to which they belong and which carries one or more connections. Thus each auxiliary path or sub-path can be determined independently of the color of the optical signals on the path LT.

A received stream is preferably switched at a node NO after information (or a message) reporting a fault on a transmission line along the path taken by the main connection is received. The information can come from a network management server (not shown) connected to the various nodes of the network or from another node, preferably the nearest node on the faulty transmission line having means for detecting the type of fault concerned.

There are two ways to implement the invention, depending on the type of protection or restoration offered by the network.

A first way, suitable for end-to-end protection or restoration, consists in equipping each transmission line LT with at least two hybrid end nodes equipped with at least one color converter module coupled to a stream switching module, and where applicable handling regeneration of the optical signals.

When the network is operating in traffic protection mode, the protection paths CP are predetermined, for example by a network management server or by the node at the upstream end of a protected (sub-)path, which is then equipped with an auxiliary path calculator module. In this case, if a hybrid end node receives information reporting a fault from the management server or the node that detected the fault, a plurality of situations can be envisaged according to the level of protection of the network. A non-exhaustive selection of these situations is discussed hereinafter.

In all the following situations at least the two hybrid nodes NO at the ends of the main (sub-)path that includes the faulty transmission line must implement switching: that on the upstream side in order to send the signal to the protection resource and that on the downstream side in order to receive that signal from the protection resource.

A first situation relates to the 1+1 protection level, whereby signals are transmitted on the main path and duplicate signals are transmitted on the associated protection path CP. In this situation, it is therefore at the downstream hybrid end node that the streams from the protection path CP are switched.

A second situation relates to the 1:1 protection level, whereby signals are transmitted along a main path and are switched to the associated protection path CP in the event of a fault on a transmission line of the main path. In this situation, it is therefore the upstream hybrid end node that configures its switching module on receiving information reporting a fault, so that each stream received is automatically switched to the protection path CP, but the downstream end node must also switch from the main path signal transport resource to the protection path signal transport resource.

A third situation relates to the 1:N protection level, whereby signals are transmitted along a main path and are switched to the protection path CP associated with N different connections in the event of a fault on a transmission line of the main path. In this situation, it is the upstream hybrid end node that configures its switching module on receiving information reporting a fault, so that each stream received is automatically switched to the protection path CP, but the downstream end node must also switch from the main path signal transport resource to the protection path signal transport resource.

When the network is operating in traffic restoration mode, the restoration paths CP are partly predetermined or have to be determined, for example by a network management server or by at least one of the hybrid end nodes (preferably the upstream hybrid end node) of each transmission line LT, which is then equipped with an auxiliary path calculator module. In this case, the hybrid end node either receives information defining the restoration path CP from the management server and the fault reporting information from the management server or from the opposite hybrid end node or receives fault reporting information from the management server or the downstream hybrid end node before determining or completing the determination of the restoration path CP. The three situations previously referred to remain applicable, depending on the level of protection of the network.

In the second situation, relating to the 1:1 protection level, it is the upstream hybrid end node that configures its switching module on receiving fault reporting information and after the restoration path CP has been entirely determined, with the result that each stream received is automatically switched to the restoration path CP, but the downstream end node must also switch from the main path signal transport resource to the protection path signal transport resource.

In the third situation, relating to the 1:N protection level, it is again the upstream hybrid end node that configures its switching module on receiving fault reporting information and after the restoration path CP has been entirely determined, with the result that each stream received is automatically switched to the restoration path CP, but the downstream end node must also switch from the main path signal transport resource to the protection path signal transport resource.

A second way, suitable for sub-path protection or restoration, consists in equipping each transmission line LT with two hybrid end nodes and at least one hybrid intermediate node, each equipped with at least one color converter module coupled to a stream switching module and where applicable handling regeneration of the optical signals.

When the network is operating in traffic protection mode, the protection sub-paths SC are predetermined, for example by a network management server or by the upstream end node of a protected (sub-)path SC which is then equipped with an auxiliary path calculator module. In this case, if a hybrid end node receives fault reporting information from the management server or from the node that detected the fault, the three situations previously referred to must be envisaged, according to the level of protection of the network.

In the first situation, relating to the 1+1 level of protection, it is therefore at the hybrid node at the downstream end of the faulty transmission line of the main path that optical signals from the protection sub-path SC concerned are switched.

In the second situation, relating to the 1:1 level of protection, it is the hybrid node at the upstream end of the faulty transmission line of the main path that configures its switching module on receiving fault reporting information so that each stream received is automatically switched to the protection sub-path SC concerned, but the downstream end node must also switch from the main path signal transport resource to the protection sub-path signal transport resource.

In the third situation, relating to the 1:N level of protection, it is also the upstream hybrid end node that configures its switching module on receiving fault reporting information so that each stream received is automatically switched to the protection sub-path SC concerned, but the downstream end node must also switch from the main path signal transport resource to the protection sub-path signal transport resource.

When the network is operating in traffic restoration mode, the restoration sub-paths SC are either partly predetermined or have to be determined, for example by a network management server or by each hybrid end or intermediate node at the end of a sub-path SC (and preferably upstream of the fault), which is equipped to this end with an auxiliary path calculator module. In this case, the hybrid end or intermediate node either receives information defining the restoration sub-path SC from the management server and fault reporting information from the management server or the hybrid node at the opposite end of the faulty transmission line or receives fault reporting information from the management server or the hybrid node at the opposite end of the faulty transmission line and then determines or completes the determination of the restoration sub-path SC. The three situations previously referred to remain applicable, according to the level of protection of the network.

In the first situation, relating to the 1+1 level of protection, it is still the hybrid node at the downstream end of the faulty transmission line that switches streams from the restoration sub-path SC once the sub-path has been fully determined.

In the second situation, relating to the 1:1 level of protection, it is the hybrid node at the upstream end of the faulty transmission line that configures its switching module on receiving the fault reporting information and after the restoration sub-path SC has been fully determined, with the result that each stream received is automatically switched to the restoration sub-path SC concerned, but the downstream end node must also switch from the main path signal transport resource to the protection sub-path signal transport resource.

In the third situation, relating to the 1:N level of protection, it is also the hybrid node at the upstream end of the faulty transmission line that configures its switching module on receiving fault reporting information and after the restoration sub-path SC has been fully determined, with the result that each stream received is automatically switched to the restoration sub-path SP concerned, but the downstream end node must also switch from the main path signal transport resource to the protection path signal transport resource.

FIG. 3 shows, in a highly schematic manner, a hybrid node NO adapted to switch in opaque mode and equipped with one example of an auxiliary path control device D according to the invention.

As previously indicated, this kind of hybrid node NO according to the invention is equipped with at least a stream switching module MC1 coupled to a color converter module MC2 which where applicable handles regeneration of the optical signals, for example 2R or 3R regeneration.

It is important to note that it is possible to start with a hybrid node merely provided with an optical signal regenerator module and to equip it with a stream switching module MC1 and a color converter module MC2.

In this example, the control device D of the hybrid node NO is also adapted to determine the auxiliary path CP or sub-path SC. In this case, the device D includes a processor module MT connected to a path calculator module MCC.

The path calculator module MCC determines an auxiliary path or sub-path independent of color, either in advance, in the case of traffic protection, or on receiving fault reporting information, in the case of traffic restoration.

The processor module MT instructs the switching module MC1, when it receives fault reporting information (or a fault report message), to switch each optical stream received by the hybrid node NO in which it is installed, either to the path CP or auxiliary sub-path SC to which the hybrid node NO is connected (in a 1:1 or 1:N situation), or from the path CP or auxiliary sub-path SC (in a 1+1 situation).

If necessary, switching can be accompanied by conversion of the color of the optical signals of the received stream by the converter module MC2, so that said stream can be transported by the path CP or auxiliary sub-path SC to which the hybrid node NO that received the stream is connected.

Of course, the device D need not incorporate a path calculator module MCC if it is installed in another network node or in a network management server.

Moreover, the device D can be installed in a centralized network management server. In this case, the processor module MT sends a switching instruction to the switching module MC1 installed in the hybrid node NO concerned.

The control device D, and to be more precise its processor module MT and calculator module MCC, can be implemented as electronic circuits, software (data processing) modules, or a combination of circuits and software.

The invention can be implemented in all types of hybrid optical networks, and especially in fiber networks and networks that switch wavelengths or bands of wavelengths (for example dense wavelength division multiplex (DWDM) networks).

Thanks to the invention, it is now possible to eliminate the constraint of color continuity between transmission lines and associated protection or restoration paths or sub-paths.

Furthermore, the invention significantly increases the usage of links between transparent nodes since color conversion now enables them to be used independently of the original color of the streams that have to use them.

Moreover, the use of hybrid nodes having opto-electronic (O/E/O) protection or restoration switching functions facilitates fault detection and link isolation. This is because, the nodes having access via the O/E/O interfaces to electrical signals that can be controlled easily, they can detect signal degradation or loss more easily than a transparent node. This is why a hybrid node at the downstream end of a transmission line can advantageously send fault reporting information to the hybrid node at the upstream end of the transmission line.

The invention is not limited to the embodiments of the method, control device D, and hybrid node NO described hereinabove by way of example only, but encompasses all variants that the person skilled in the art might envisage falling within the scope of the following claims.

1. A method of controlling auxiliary paths (CP, SC) in a hybrid optical communications network comprising a multiplicity of hybrid nodes (NO, NT) interconnected by transmission lines, which method is characterized in that, in the event of a fault on a transmission line along which a connection passes, the method consists in determining at least one auxiliary path independent of color between the hybrid nodes (NO) at the ends of said faulty transmission line and at which said connection can be switched in opaque mode, and then in switching optical signals taking said connection to said auxiliary path, where applicable after color conversion.

2. A method according to claim 1, characterized in that said optical signals are switched on receiving information reporting said fault on said transmission line.

3. A method according to claim 2, characterized in that said auxiliary path is a restoration path (SC) determined on receiving said information.

4. A method according to claim 3, characterized in that said auxiliary path is a restoration path (SC) that is at least partly predetermined before receiving said information.

5. A method according to claim 1, characterized in that said auxiliary path is a precalculated, pre-established, and prereserved protection path (CP).

6. A method according to claim 3, characterized in that said auxiliary path (CP, SC) is determined or predetermined in at least one of the two hybrid nodes (NO) at the ends of said faulty transmission line.

7. A device (D) for controlling auxiliary paths (CP, SC) in a hybrid optical communications network comprising a multiplicity of hybrid nodes (NO, NT) including switching means (CM1) and color converter means (CM2) and interconnected by transmission lines (LT), which device is characterized in that it comprises processor means (MT) adapted, in the event of a fault on at least one of said transmission lines carrying a connection and at the ends of which are two hybrid nodes (NO) adapted to effect switching in opaque mode, to command said switching means (CM1) of at least one of said two hybrid nodes to switch the optical signals taking said connection to a selected auxiliary path (CP, SC) independent of color and passing through said nodes (NO), where applicable after color conversion of said optical signals by said associated converter means (CM2).

8. A device according to claim 7, characterized in that said processor means (MT) command said switching of said optical signals on receiving information reporting the fault on said connection portion.

9. A device according to claim 8, characterized in that it includes calculator means (MCC) adapted to determine said auxiliary path (SC) on receiving said information, said auxiliary path so determined being said restoration path.

10. A device according to claim 8, characterized in that, said auxiliary path being a restoration path (SC) that is at least partly predetermined before receiving said information, said device (D) includes calculator means (MCC) adapted to complete said determination of said restoration path (SC).

11. A device according to claim 7, characterized in that said auxiliary path is a precalculated, pre-established and prereserved protection path (CP).

12. A management server for a hybrid optical communications network, characterized in that it includes a control device (D) according to claim 7.

13. A hybrid node (NO) for a hybrid optical communications network, characterized in that it includes a switching module (MC1), a color converter module (MC2) and a control device (D) according to claim 7.

14. A hybrid node according to claim 13, characterized in that it includes a regenerator module adapted to regenerate each optical resource received.

15. A hybrid optical communications network, characterized in that it includes at least two hybrid nodes (NO) according to claim 13 at the opposite ends of a transmission line (LT) carrying a connection.

16. A hybrid optical communications network, characterized in that it includes at least one management server according to claim 12.

17. Use of the method, control device (D), management server, and hybrid node (NO) according to claim 1 in hybrid optical communications networks selected from wavelength switching networks, band of wavelength switching networks, and cable networks.
